(19) United States
(12) Patent Application Publication
(10) Pub. No.: US 2003/0178811 A1
(43) Pub. Date: Sep. 25, 2003

(54) Torsion trailer hitch

(76) Inventor: Lynn Allan Buckner, Chickamauga, GA (US)

Correspondence Address: Lynn A. Buckner, P.O. Box 609, Chickamauga, GA, 30707, US

(21) Appl. No.: 10/378,258

(22) Filed: Mar. 4, 2003

Related U.S. Application Data
(60) Provisional application No. 60/362,852, filed on Mar. 7, 2002.
(60) Provisional application No. 60/363,064, filed on Mar. 11, 2002.
(60) Provisional application No. 60/368,971, filed on Apr. 2, 2002.

(51) Int. Cl. B60D 1/00

(52) U.S. Cl. 280/483

(57) ABSTRACT

The present invention relates to a vehicle towing hitch or trailer coupler method of reducing bounce or shock motion from being transmitted between the towing vehicle and towed vehicle or trailer, thus allowing a towing vehicle to tow a trailer over a rough road while reducing the bounce effect of the trailer from being transferred to the towing vehicle and visa versa. Said towing hitch or trailer coupler further comprises two or more parallel arms attached to one or more torsion axle as the preferred means to both support the towing load and also dampen the road bounce and shock load. The dampening means may be mounted on the towing vehicle or the trailer coupler.

### BACKGROUND OF THE INVENTION

1. Field of the Invention

The present invention relates to a vehicle towing hitch or trailer coupler method of reducing bounce or shock motion from being transmitted between the towing vehicle and towed vehicle or trailer, thus allowing a towing vehicle to tow a trailer over a rough road while reducing the bounce effect of the trailer from being transferred to the towing vehicle and visa versa. Said towing hitch or trailer coupler further comprises two or more parallel arms attached to one or more torsion axle as the preferred means to both support the towing load and also dampen the road bounce and shock load. The dampening means may be mounted on the towing vehicle or the trailer coupler.

2. Description of the Related Art

Current state of the art vehicle towing hitches or trailer couplers are rigidly mounted to the towing vehicle. Rough roads cause trailers to bounce up and down thus transmitting the trailer bounce to the towing vehicle via the rigid mounted trailer hitch.

The primary objective of the present invention is to provide a towing hitch or trailer coupler with the capability and capacity to absorb the up and down trailer bounce energy.

It is yet another objective of the present invention to provide a means to both dampen up or down motion and support the load of the towed trailer.

It is yet another objective of the present invention to provide a torsion axle as the means of supporting the load of the towed trailer and dampen the up or down motion being transferred between the trailer and the towing vehicle.

### SUMMARY OF THE INVENTION

The above described objectives and others are met by placing a means of absorbing or reducing movement or shock energy or up or down movement from being transferred between a towing vehicle and a towed vehicle or towed trailer. A moveable lever arrangement or flexible means accompanied by a shock absorbing means may be located between a towing vehicle and its ball hitch or be placed on the towed trailer between the trailer and its hitch coupler.

A moveable lever arrangement may be two or more parallel arms arranged to move simultaneously so as to substantially maintain a level hitch arrangement while allowing up or down movement.

A shock absorbing means may be one or more torsion axles, flexible torsion means or an air spring or an air bladder or a compression spring or a spring, a shock absorber, or a torsion arm.

### BRIEF DESCRIPTION OF THE DRAWINGS

FIG. 1A is a side elevation of a plug-in receiver for a towing vehicle showing a rubber torsion axle attached to the receiver hitch with attached parallel arms which support and allow substantially level ball hitch movement up or down. The shock absorbing characteristics of the torsion axle stablelizes and absorbs and reduces bounce energy from being transferred between the towed and towing vehicles.

FIG. 1B is a top view of the rubber torsion axle with attached parallel support arms.

FIG. 1C is a side detail of the ball mount with support shaft to attachment means for the parallel primary support arms.

FIG. 2 is a side elevation of a towing vehicle receiver hitch with a torsion axle mounted to it. The torsion hitch has a single primary support arm attached between the torsion axle and the ball mount, thus the ball moves up or down in an arc motion.

FIG. 3 is similar to FIG. 1A except that a compression spring is used as the shock absorbing means.

FIG. 4A is a side elevation of a vertical movement means of attaching a receiver hitch to a ball hitch. An air spring or air bladder is shown as a shock absorbing means.

FIG. 4B is a top view of FIG. 4A.

FIG. 4C is a top view of attachment plates.

FIG. 5A is a side view similar to FIG. 1A except that two parallel torsion axles are used.

FIG. 5B is a side view of the torsion axle

FIG. 5C is an end view of the torsion axle.

FIG. 6A is a side view of a towing vehicle.

FIG. 6B is a side view of a parallel torsion axle receiver hitch means to be plugged into the towing vehicle receiver.

FIG. 6C is a side view of a parallel torsion axle hitch attachment means shown between the trailer and the hitch coupler.

FIG. 6D is a side view of a parallel torsion axle hitch attachment means shown between a 5^{th} wheel trailer and its hitch coupler.

FIG. 7 is a side view of a gooseneck trailer with three parallel torsion axle means shown located between the trailer and the coupler.

FIG. 8 is a side view of an air spring being used as the energy absorption means between a tractor trailer and its coupler hitch.

### DETAILED DESCRIPTION OF THE PREFERRED EMBODIMENT

Using the drawings, the preferred embodiment of the present invention will now be explained.

Current state of the art vehicle towing hitches or trailer hitches are rigidly mounted to the towing vehicle. Rough roads cause trailers to bounce up and down thus transmitting the trailer bounce to the towing vehicle via the rigid mounted trailer hitch.

The purpose of this invention is to provide a towing hitch or trailer hitch with the capability and capacity to absorb the up and down trailer bounce energy. The torsion trailer hitch allows the trailer to bounce up and down without transmitting the bouncing energy to the towing vehicle, thus the trailer bounce does not cause the tow vehicle to bounce. The trailer torsion hitch is divided into two sections, which can move independently of each other. A rubber torsion axle, compression spring, air spring, air bladder or extension spring are examples of energy absorbing techniques which may be placed between the two sections. The energy absorbing techniques reduce or prevent bounce created in one section of the trailer hitch from being transmitted into the other section of the trailer hitch.

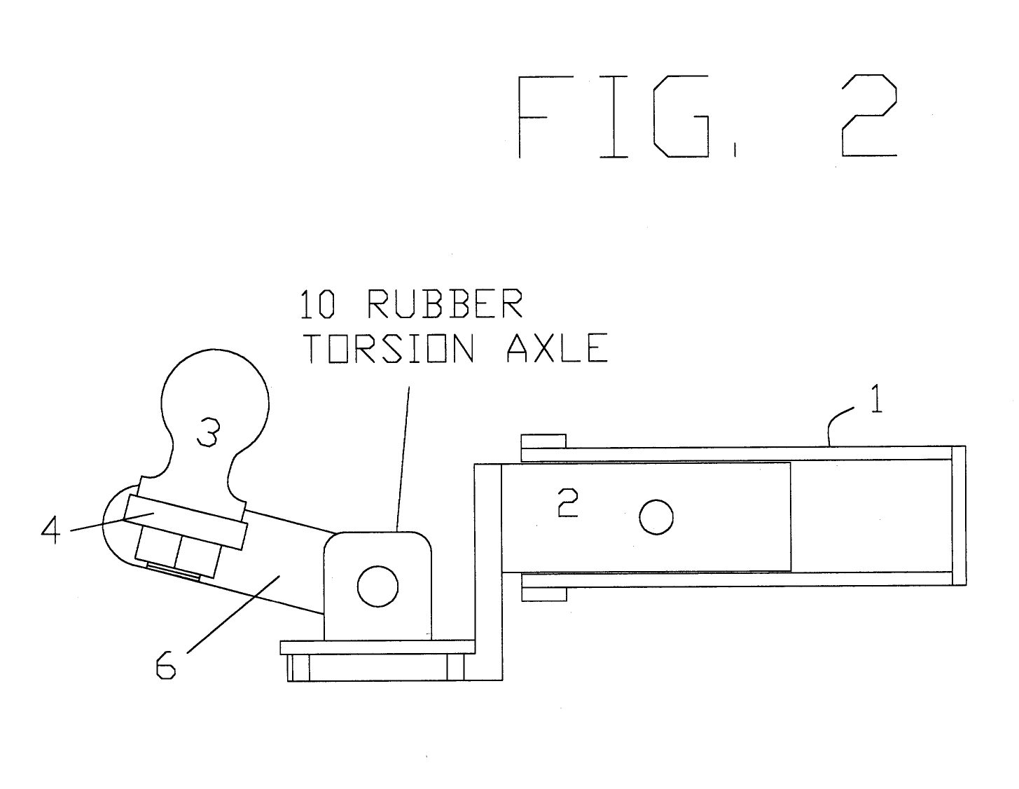

The rubber torsion axle device is a preferred method of dampening the energy between the two independently mobile portions of the torsion trailer hitch. The rubber torsion axle 10 consists of four primary components: an outer foundation tube, a rubber cartridge, an inner shaft and a shaft arm, being support arm 6. The trailer hitch ball 3 or trailer coupler 23, 24, 25, or 26 is attached to the shaft arm 6. The outer foundation tube 10A is attached to the tow vehicle or the trailer. The rubber cartridge, 10B provides strength, flexing and energy dampening between the two sections. As shown in FIG. 2, the trailer ball 3 can be rigidly attached to shaft arm 6. In this configuration the radius travel of the shaft arm 6 causes the trailer ball 3 to vary in angle as related to the receiver 1 as the shaft arm 6 rotates on its fulcrum support shaft 10C.

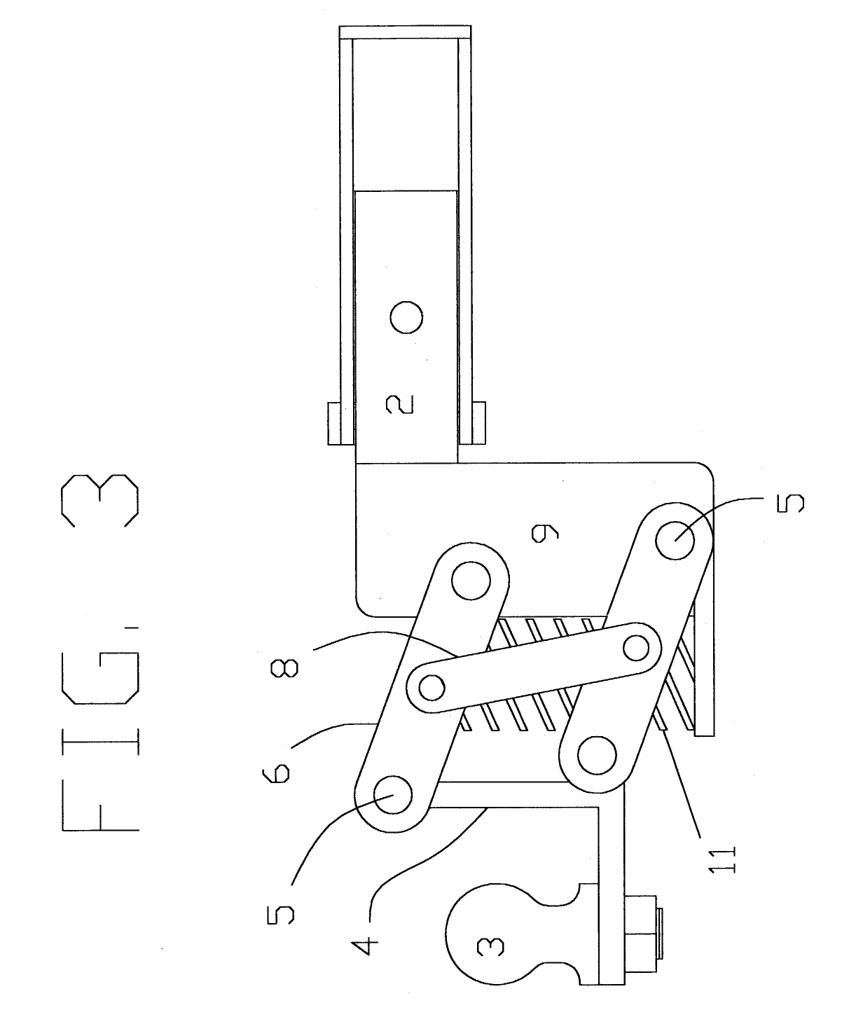

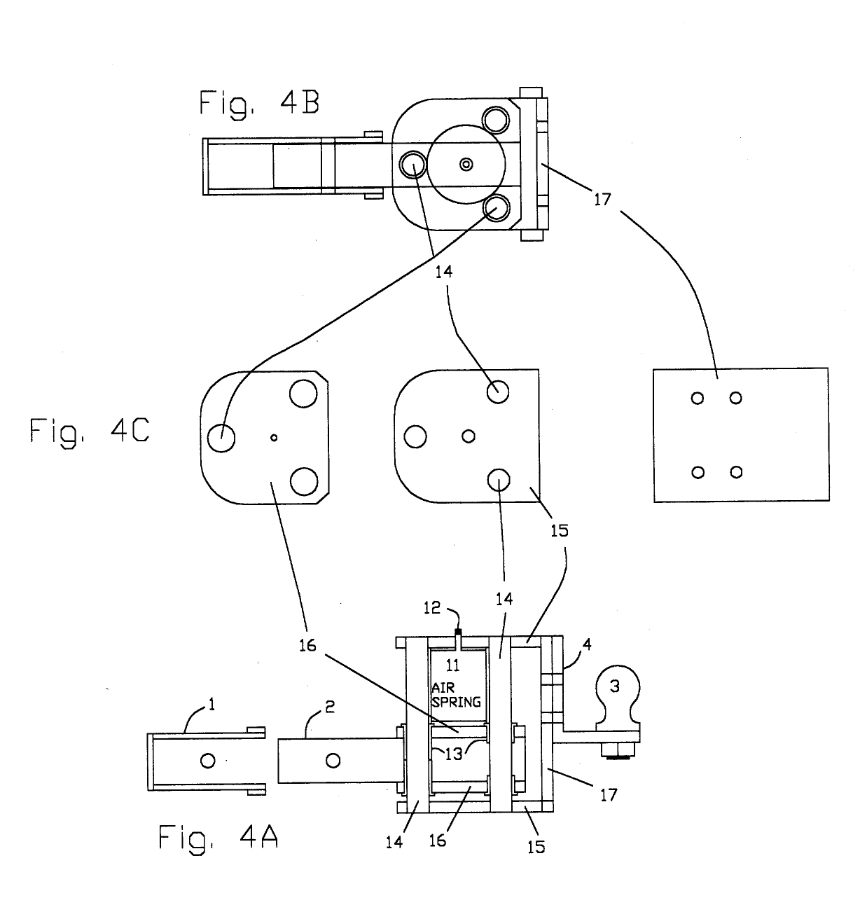

A single primary support arm 6 attached to a torsion support shaft is functional. A preferred torsion device utilizes two or more parallel primary support arms 6 mounted at one end to a coupler 4, 23, 24, 25, or 26 by a support shaft 5 or 10C and the other end is attached by a support shaft 5 or 10C to the powered towing vehicle or the trailers to be towed. A torsion trailer attached as a fixed part of the trailer 20 or 22 or as a fixed part of the powered mobile vehicle 21 as shown in drawings 6, 7, or 8. Although drawings 6, 7, or 8 show a rubber torsion axle style torsion trailer hitch, the rubber torsion axle device may be substituted with a spring 11 style device as shown in drawing FIG. 3 or air spring, or air bladder style device as shown in drawing FIG. 4. FIG. 4 is an example of using an energy absorbing device 11 between the two primary portions of the torsion trailer hitch, in example drawing FIG. 4 the two primary portions move in a vertical direction supported by and guided by vertical shaft 14.

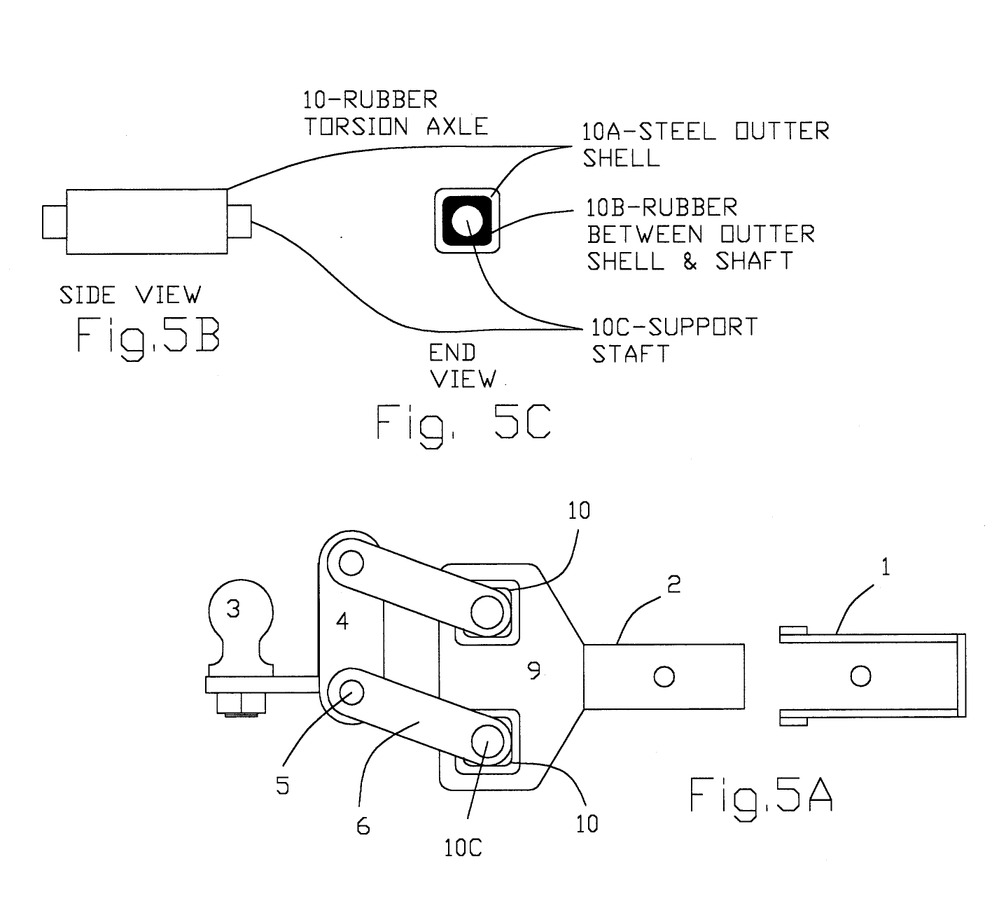

In FIG. 5, items 3, 4 and 5 represent a first portion of the torsion trailer hitch and items 10, 9 and 2 represent a second portion of the torsion trailer hitch. Two parallel primary support arms 6 attach the two primary portions of the torsion trailer hitch. The two parallel primary support arms 6 allow the first portion to remain stable and maintain its orientation while moving up and down with the vertical forces applied to it by the trailer and towing vehicle.

In FIG. 4, items 3, 4, 15 and 14 represent a first portion of the torsion trailer hitch and items 2, 13 and 16 represent a second portion of the torsion trailer hitch. An energy absorbing device 11 is placed between the two portions.

In FIG. 3, items 3, 4 and 5 represent a first portion of the torsion trailer hitch and items 2, 9 and 5 represent a second portion of the torsion trailer hitch. An energy-absorbing device 11 is placed between the two portions.

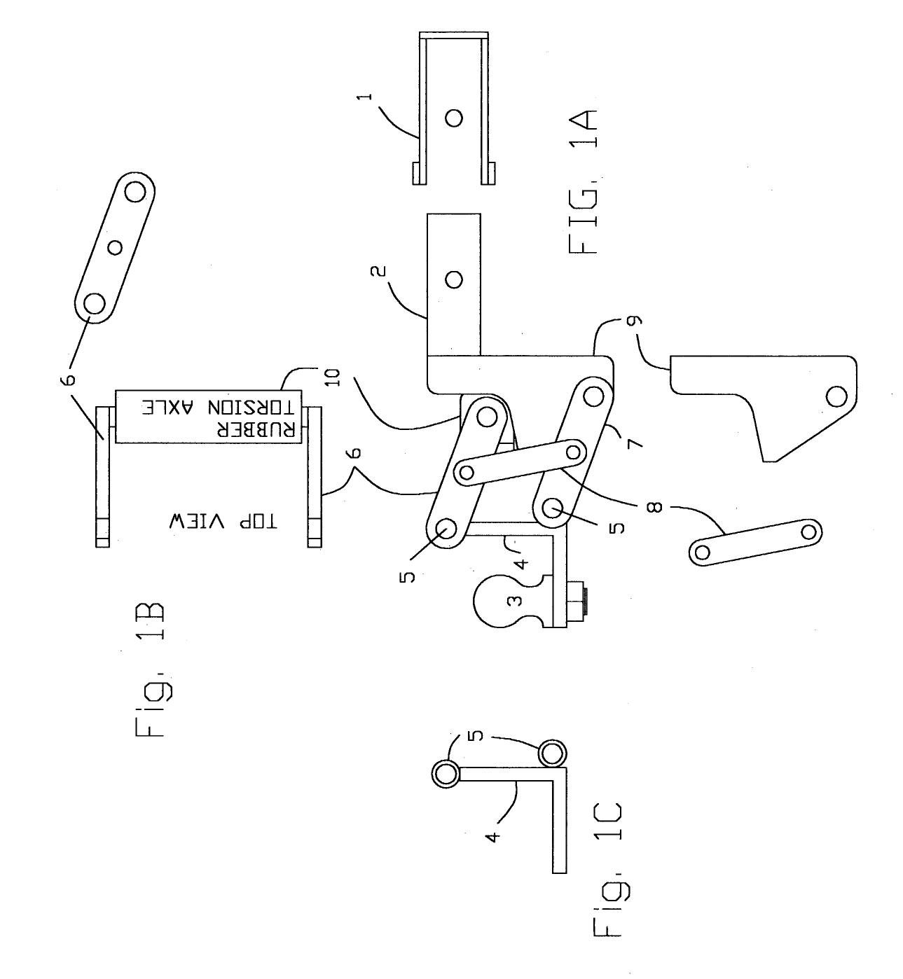

FIG. 1 drawing is similar to FIG. 2 except that the trailer ball 3 is maintained in a level configuration even though it moves up and down by means of the shaft arm 6. Ball mount 4 pivots on support sleeve 5. Stabilizer arm 7 is geometrically dimensioned and located so as to stabilize the ball mount 4 in a level configuration as the support arm 6 moves up and down. The connector, arm 8, adds to the geometry of the stabilizer arm 7 so as to maintain a parallel relation between support arm 6 and stabilizer arm 7.

FIG. 2 a single primary support arm rubber torsion axle torsion trailer hitch.

FIG. 3 is the same as FIG. 1 in principle except that the rubber torsion axle is replaced with other torsion techniques such as a compression spring, air spring, air bladder or extension spring.

FIG. 4 is an example of placing a torsion device directly above or directly beneath the two sections of the torsion trailer hitch. Vertical guide shafts 14 are utilized to restrict movement to a vertical up and down motion. Vertical guide bushings 13 or linear bearings 13 reduce friction. Foundation plates 15 and 16 provide surfaces to support each of the two sections. A torsion or energy-absorbing device 11 is placed between the two sections. As shown in this example, air pressure is used as an absorbing cushion between the two sections. Increasing or decreasing the air pressure through valve 12 increases and decreases the load capacity and dampening effect between the trailer and towing vehicle.

FIG. 5 shows a torsion trailer hitch of the rubber torsion axle style and the drawing displays details of the rubber torsion axle.

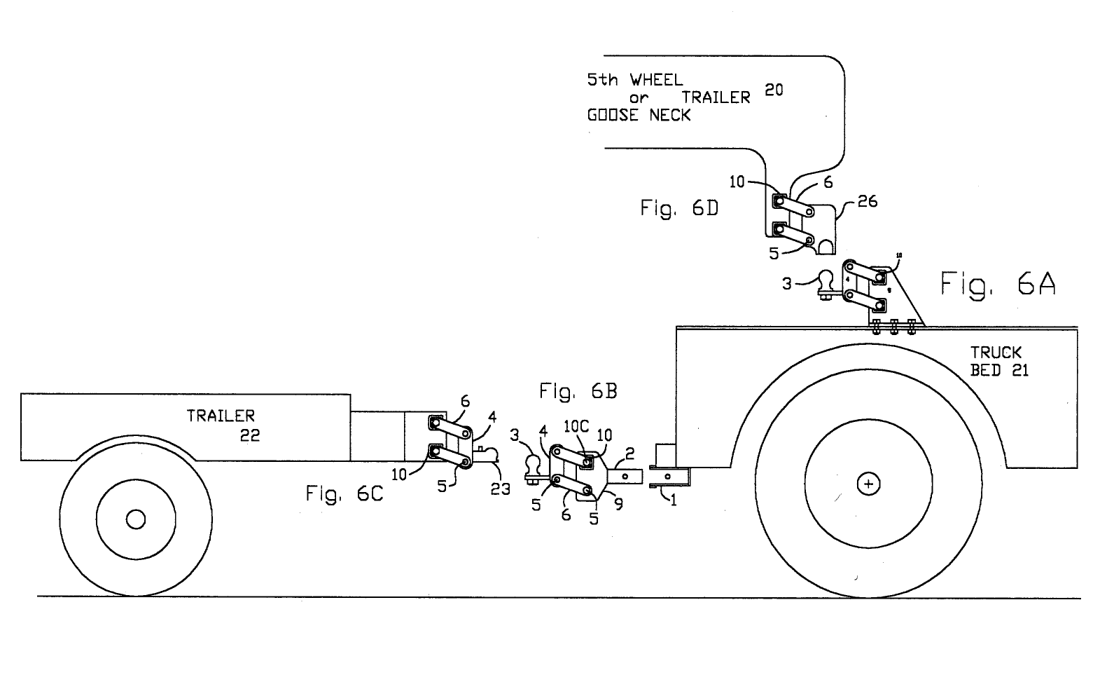

In FIG. 6, the torsion trailer hitch is shown mounted in numerous configurations. The torsion trailer hitch may be mounted as a component of a tag along trailer 22, a component of a gooseneck trailer 20 or the torsion trailer hitch may be mounted as a component of the towing mobile vehicle to couple a fifth wheel trailer or gooseneck trailer.

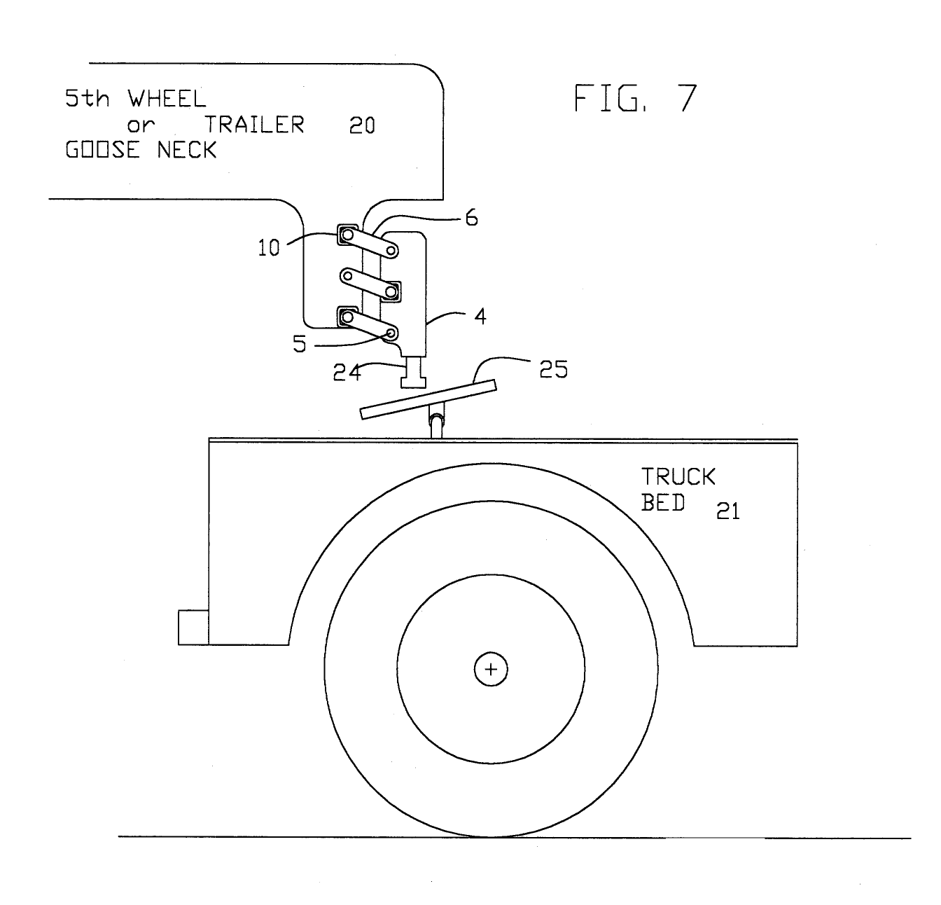

FIG. 7 shows an example of the torsion trailer hitch being mounted as a part of the fifth wheel trailer. In this example, three parallel torsion axle 10 units are attached to the male fifth wheel coupler 24 by 3 parallel support arms 6.

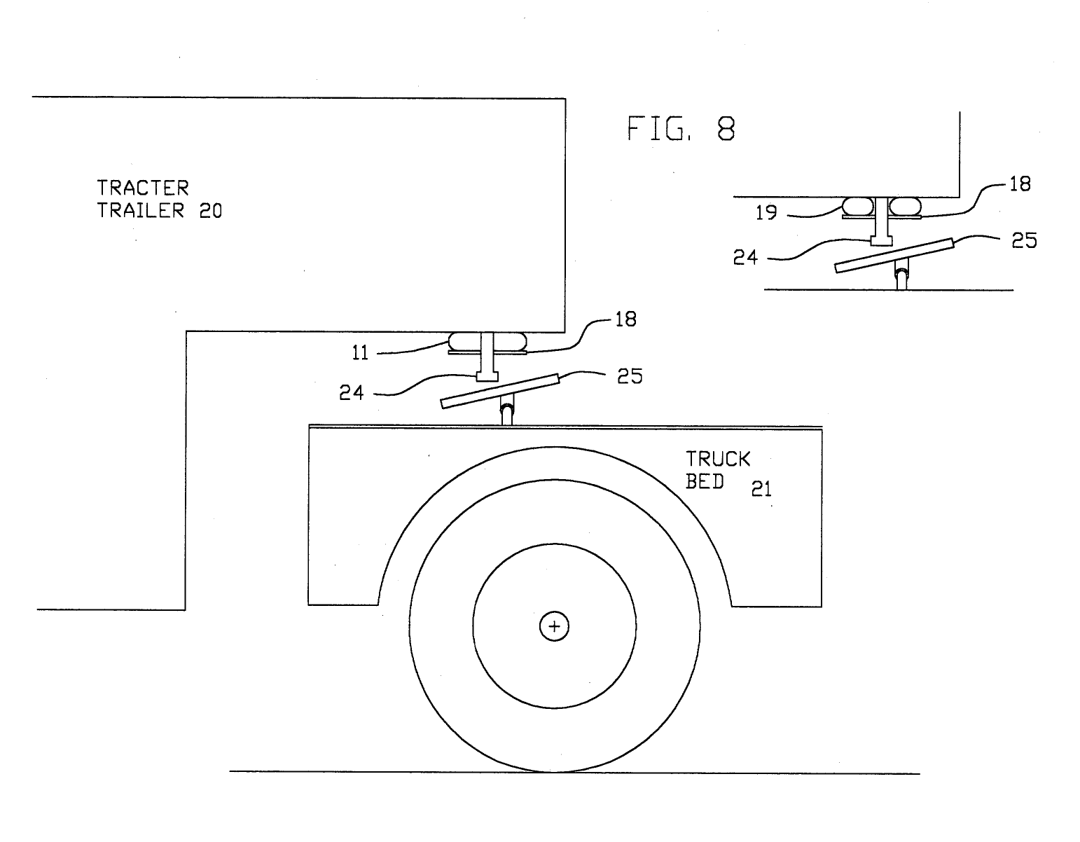

FIG. 8 show an example of the torsion trailer hitch in the form of an energy absorbing device 11 and 19 being placed between the tractor trailer 20 and the fifth wheel male coupler 24 with a friction plate placed between them. The energy absorbing device 11 absorbs bounce as the trailer 20 moves up and down while attached to the powered mobile towing fifth wheel hitch 26.

What is claimed:

1. A trailer hitch means to attach a towing vehicle to a towed vehicle or trailer comprising:
A fixed towing vehicle attachment means having two or more moveable parallel support arms attached to the fixed attachment means at a first end and to a trailer connector at a second end;
An energy absorbing means attached between the towing vehicle fixed attachment means and the moveable parallel support arms.

2. A trailer coupler means to attach a trailer to a towing vehicle comprising:
A fixed trailer attachment means having two or more moveable parallel support arms attached to the fixed attachment means at a first end and to a vehicle coupler means at a second end;
An energy absorbing means attached between the trailer fixed attachment means and the moveable parallel support arms.

3. The means in claim 1 or 2 wherein said energy absorbing means is one or more chosen from a rubber torsion axle, a torsion arm, a flexible torsion means, an air spring, an air bladder, a compressive spring, a spring or a shock absorber.

4. The means in claim 1, 2, or 3 wherein the bounce energy absorbing means is a part of the towing is a part of the towing vehicle hitch system.

5. The means in claim 1, 2, or 3 wherein the bounce energy absorbing means is a part of the towed trailer coupler system.

6. A trailer hitch means to attach a towing vehicle to a towed vehicle or trailer comprising:
A fixed attachment means having one or more vertical columns;
A moveable support sleeved in proximity, to the vertical columns having a trailer hitch or coupler attached;
A bounce absorbing means attached between said fixed attachment means and said moveable, sleeved support means.

7. The means in claim 6 wherein said energy absorbing means is one or more chosen from a rubber torsion axle, a torsion arm, a flexible torsion means, an air spring, an air bladder, a compression spring, a spring or a shock absorber.

8. The means in claims 6 or 7 wherein the bounce energy absorbing means is a part or the towing vehicle trailer hitch system.

9. The means in claim 6 or 7 wherein the bounce energy absorbing means is a part of towed trailer or towed vehicle coupler system.
